(19) United States
(12) Patent Application Publication
(10) Pub. No.: US 2023/0058685 A1
(43) Pub. Date: Feb. 23, 2023

(54) Layered Drink or Dessert Dispensing Apparatus

(71) Applicants: Jim Wheeler, Sheridan, WY (US); Justina Almanza, Sheridan, WY (US)

(72) Inventors: Jim Wheeler, Sheridan, WY (US); Justina Almanza, Sheridan, WY (US)

(21) Appl. No.: 17/881,001

(22) Filed: Aug. 4, 2022

Related U.S. Application Data
(60) Provisional application No. 63/232,867, filed on Aug. 13, 2021.

(51) Int. Cl. A23G 9/28; A23G 9/16; A23G 9/22; A23G 3/02

(52) U.S. Cl. CPC A23G 9/283; A23G 9/166; A23G 9/228; A23G 3/0242

(57) ABSTRACT

A layered drink or dessert dispensing apparatus that accepts a single serving container and transfers the container through a grater that transfers the product into a cup glass or bowl while maintaining the layers. The dispensing apparatus pushes the product through the container while the grater turns. The container is configured in a non-round shape, so the consumer container does not rotate as the grinder or grater is rotated under the container. The grater has one blade or a plurality of teeth or scoops that “cut” through the layered product in the consumer container to extract, remove and scoop the beverage or dessert. The course configuration of the grater minimizes harm to pulp, fibers and/or seeds that may exist in the drink or dessert. Different layers with different densities and material are all equally removed and fall through the dispensing apparatus.

### CROSS REFERENCE TO RELATED APPLICATIONS

This application claims the benefit of Provisional Application Ser. No. 63/232,867 filed Aug. 13, 2021 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a machine for dispensing layered beverages or desserts. More particularly, the present layered drink or dessert dispensing apparatus allows for a layered pre-packaged container to be dispensed into a glass or cup while maintaining the layers in the pre-packaged container.

### Description of Related Art Including Information Disclosed Under 37 CFR 1.97 and 1.98

Desserts and drinks come in a large number of types and styles. Many drinks are mixed or blended to provide a homogeneous consistency. A number of other drinks and desserts are configured in layers with each layer having a different flavor and consistency. One problem with serving these layered products is maintaining the layers from preparation to delivery. Maintaining a large inventory of different ingredients can be logistically difficult. Cold, refrigerated, or frozen products creates another challenge due to the high viscosity of the ice cream and other products that can change as a function of temperature. Another issue is layering the product from a disposable container into a cup, glass, or bowl where the cross-section can be quite different while maintaining the different layers for an individual consumer product in a dispensing machine.

Some inventions have been made to use multiple dispensing nozzles to dispense each layer separately to produce a layered result. Other inventions co-extrude product, and some just provide a homogeneous mixed product to avoid the issues related to providing a customer with a layered product. A number of patents and or publications have been made to address these issues. Exemplary examples of patents and or publication that try to address this/these problem(s) are identified and discussed below.

U.S. Pat. No. 5,069,364 issued on Dec. 3, 1991, to Shane R. McGill and is titled Dispensing Apparatus. This patent discloses a dispensing apparatus is provided for dispensing a frozen product, such as ice cream, in portions. The apparatus uses a prefilled deformable container of product which is in a housing of the apparatus. Dispensing means is operated by the drive and a valve controls the discharge of product during dispensing. To maintain the product at a low temperature the container and the outlet are in a refrigerated housing. While this patent discloses dispensing a product into a cup, the product is not layered.

U.S. Pat. No. 5,823,392 issued on Oct. 20, 1998, to Carlos Cano Madico and is titled Yogurt/cereal grain mixture dispensing machine. This patent discloses a device for filling cups with yogurt and a portion of corn flakes, kiwicha or similar product, wherein portions of two flavors of yogurt are and measured portions of the selected yogurt and solid food product are dispensed into a cup by the operator. While this patent discloses a layered product, the separate layers are dispensed from separate sections from within the machine.

U.S. Pat. No. 5,893,485 issued on Apr. 13, 1999, to Gary Shane McGill and is titled Dispensing Machine. This patent discloses a dispensing mechanism is primarily intended for dispensing food products, such as ice cream, in semi-solid form. The machine has application in dispensing portion-sized containers of product. The containers are then located in a discharge unit and the container, or the closure member is deformed on operation of the unit. The product is discharged through an outlet in the container. While this patent discloses dispensing a product into a cup, the product is not layered.

U.S. Pat. No. 10,595,544 issued on Mar. 24, 2020, to Barak Beth Halachmi and is titled System, machine, and method for the preparation of cooled edible products. This patent discloses a system, machines, and consumables for the preparation of portioned amount of a cooled edible product constituting a defined number of servings which may be 1, 2, 3, etc. are provided. One example of such an edible product is ice cream. The cooled edible product is a homogeneous mixture.

What is needed is an apparatus that is configured to produce a layered single serve product. The proposed layered drink or dessert dispensing apparatus provides the solution.

### BRIEF SUMMARY OF THE INVENTION

It is an object of the layered drink or dessert dispensing apparatus to provide an apparatus that accepts a single serving container. The single serving container allows the dispensing apparatus to be used with a variety of different drinks and desserts. The various drinks and desserts can be stored in a sealed refrigerated or frozen condition. A user can select or purchase the individual product and then place the container in the dispensing apparatus where the product is transferred into a user or consumer cup glass or bowl while maintaining a layered configuration. While a layered product is shown or described the product can be a homogeneous product such as ice cream, slush drink or frozen yogurt.

It is an object of the layered drink or dessert dispensing apparatus to transfer a layered serving from a container into a consumer glass, cup or bowl while maintaining the separate layers. The transfer is by passing the product through a grinder, grater that shears the product from the container as the container is compressed. The grinder or grater turn under the product as the layered product is pushed through the grinder or grater. This removes layers of the product to maintain the layered product until the entire contents of the product is expelled. The grinder or grater operates with thick liquids to semi-solid frozen products. Different layers with different densities and material are all equally removed and fall through the dispensing apparatus while the layers are maintained.

It is another object of the layered drink or dessert dispensing apparatus to work with chilled viscus materials for beverages or desserts. The consumer container is configured in a non-round shape, so the consumer container does not rotate as the grinder or grater is rotated under the consumer container. While the consumer container could be rotated over a fixed grater or grinder the layered product would be deposited in the cup glass or bowl in a similar layered condition for consumption.

It is still another object of the layered drink or dessert dispensing apparatus to pass the dispensed product through a rotating grater to eviscerate the product from the dispensing container and maintain the layers. The grater or grinder has one blade or a plurality of teeth or scoops that “cut” through the layered product in the consumer container to extract, remove and scoop the beverage or dessert. The course configuration of the grater or grinder minimizes harm to pulp, fibers and/or seeds that may exist in the drink or dessert.

The dispensing apparatus operates with a single start button that begins the process of turning the grater or grinder, compressing an end of the consumer container to push the drink or dessert. A plurality of sensors monitors the motors and position of the moving components without any human interaction. The sensors also check for the correct position of the consumer container, cup glass or dish and any potential harm for a user interfering with the dispensing process.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of a layered drink or dessert dispensing apparatus with a consumer container.

FIG. 2 shows a perspective view of the dispensing apparatus with some housing pieces removed.

FIG. 3 shows a detailed view of the drive system with the grater plate.

FIG. 4 shows the compression and rotational drive system.

FIG. 5 shows a cross-section of the dispensing apparatus with a parfait being dispensed.

FIG. 6 shows a block diagram of the dispensing apparatus.

FIG. 7 shows a flow chart for using the dispensing apparatus.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

Item Numbers and Description

| | |
|---|---|
| 10 dispensing apparatus | 14 side power connection |
| 15 battery connection | 16 power switch |
| 17 power connection | 18 controller |
| 19 power supply | 20 right side housing |
| 21 left side housing | 22 front cover |
| 23 door | 24 base |
| 25 collection tray top | 25B collection tray bottom |
| 26 cup, glass, bowl | 27 back |
| 29 start button | 30 opening |
| 31 receiver side(s) | 32 receiver top |
| 33 anti-rotation frame | 34 multi-sided receiver |
| 35 frame | 40 sidewall pattern |
| 50 rotation motor | 51 drive pulley |
| 52 belt | 53 inner ring |
| 54 driven pulley | 55 overflow lip |
| 56 hub | 60 grinder/grater plate |
| 70 press motor | 71 screw |
| 72 ram | 72L lowered ram |
| 94 moves | 95 turns |
| 98 down | 99 turns |
| 100 single serving container | 101 upper lip |
| 102 base | 103 sides |
| 104 drink or dessert | 110 transmitter/receiver |
| 111 antenna | 112 communication |
| 129 LED | 123 door sensor |
| 151 turn sensor | 172 ram sensor |
| 200 start | 210 power on |
| 215 home ram | 220 user purchase |
| 230 wait for start | 240 no, flash LED |
| 250 door closed | 260 start grater |
| 265 run ram | 270 check EOS |
| 275 stop grater | 280 lift ram |
| 290 done | |

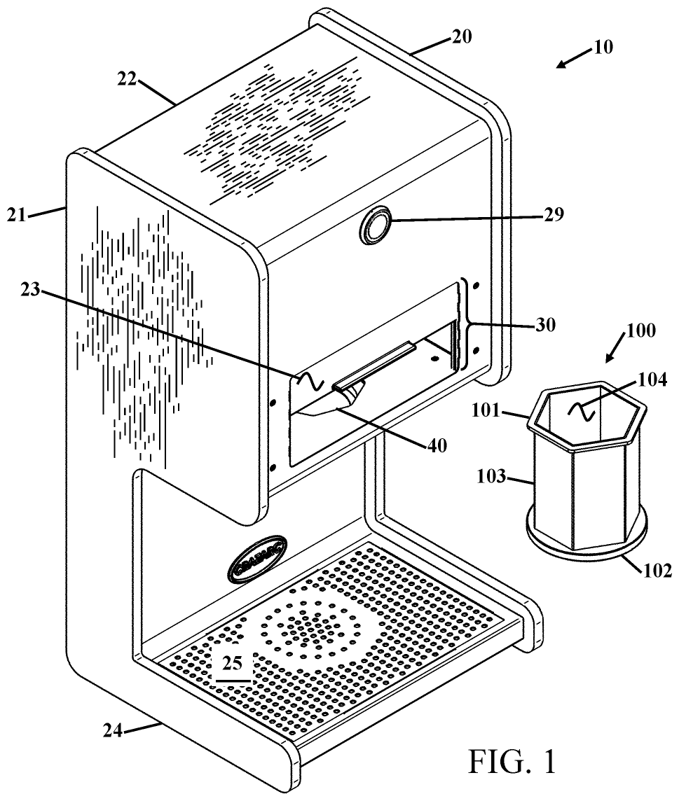

FIG. 1 shows a perspective view of a layered drink or dessert dispensing apparatus 10 with a consumer container 100. This figure provides a general overview of the components as viewed by a user. The dispensing apparatus 10 is formed with an upper portion where the consumer container 100 is placed within the opening 30 through the door 23. In this embodiment there is a left side housing 21 and a right-side housing 30 with a cover 22 or front cover secured therein between. The door 23 is closed and monitored while the dispensing apparatus 10 dispenses a product from the single serving container or consumer container 100.

After a user, or consumer places the consumer container 100 into the dispensing apparatus 10, they will close the door 30 and press a start button 29 that will begin the operation to dispense the drink, dessert, parfait or other product into a glass, cup or bowl placed on the collection tray top 25 at the base 24 of the dispensing apparatus 10.

The single serving container 100 is configured as a multi-sided container with an upper lip 101, a base 102, sides 103 and an interior cavity where the drink or dessert 104 product is stored. While this embodiment is for a consumer, it can also be used in an industrial setting. The single serving container 100 is preloaded and sealed. A consumer can purchase the desired drink or dessert, removes seals from the ends of the single serving container 100 and then insert the single serving container 100 into the dispensing apparatus so the sides of the single serving container 100 are engaged in the sidewall pattern 40 in within the opening 30. The multiple sides of the single serving container all allow for the single serving container 100 to be inserted in several orientations and also prevents the single serving container 100 from rotating as the product is being dispensed.

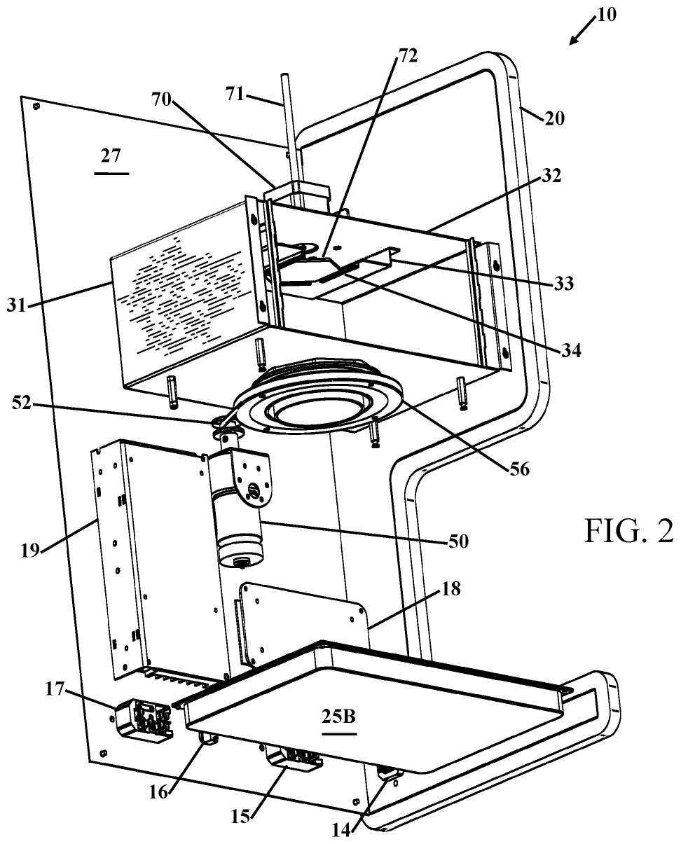

FIG. 2 shows a perspective view of the dispensing apparatus 10 with some housing pieces removed with the right side 20 and the back 27 remaining. Starting at the bottom of this figure, there are three power connections. While there are three connections a single connection is contemplated. The three connections are for an 110 AC voltage 17, a battery connection 15 that allows the dispensing apparatus 10 to operate from a 12 VCD power as might be available from a car automobile battery and an alternate power connection 14 that could be from an international source. The alternative connection 14 could also be for 100 VAC and allow the dispensing apparatus 10 to be placed flush against a wall. It is also contemplated that the power connections 14, 15 and 17 could include integrated circuit breakers and power switches. A power switch 16 can be used to supply power to the dispensing apparatus 10. The bottom of this figure also shows the bottom of the collection tray bottom 25B that collects any fluid or material that can flow onto the top of the tray.

The back wall of the dispensing apparatus 10 has a power supply 19 converter that receives the incoming power and converts it to a voltage for controlling the electronics. A controller 18 controls the logic and operates the motors and sensors. The rotation motor 50 uses a belt 52 that connects to the rotating hub 56 that is shown and described in other figures herein. With some of the outer housing removed the receiver top 32 and the receiver sides 31 of the frame is visible. Within the frame is an anti-rotation frame 33 that prevents the single serving cup (not shown in this figure) from rotating. The multi-sided top of the single serving cup is placed within the multi-sided receiver 34 so the rain 72 can pass into the top of the single serving cup. The rain 72 is connected to a threaded screw rod 71 and passes through a press motor 70 that moves the rain 72 in and out of the single serving cup to dispense product.

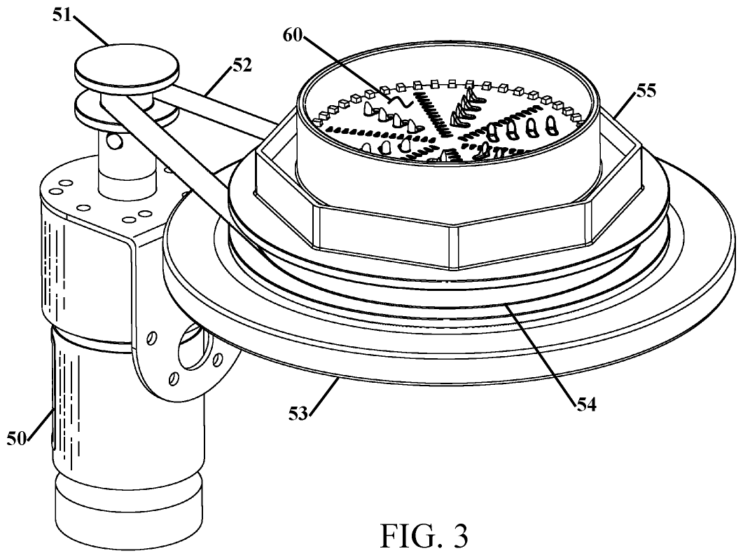

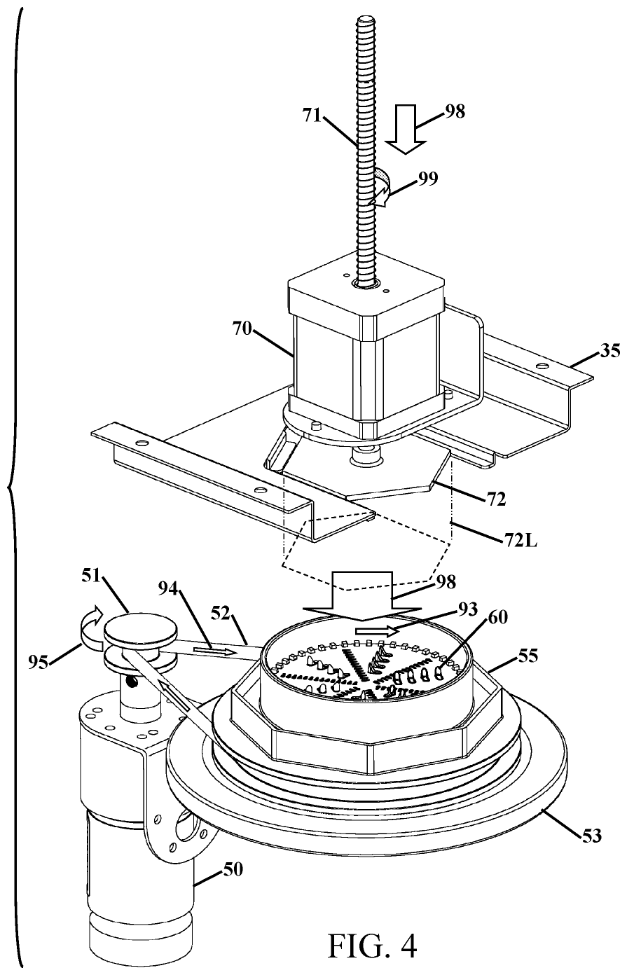

FIG. 3 shows a detailed view of the drive system with the grater plate and FIG. 4 shows the compression and rotational drive system. To transfer the layered beverage or dessert from the individual use container to the point-of-use cup glass or bowl the layered beverage or dessert is shaved or grated. The layered beverage or dessert is pushed into a plate having a grinder/grater 60 holes while the grinder/grater 60 is turned. While this figure shows the grinder/grater as a plurality of blades and/or scoops the shaving mechanism could be a single blade that shaves helical layers of the layered beverage or dessert. The rotational motor 50 has a drive pulley 51 that moves a belt 52. The belt 52 wraps at least partially around a driven pulley 54 to turn the grinder/grater blade 60. The grinder/grater 60 can exist in the bottom of the single serving container so it is a single use and does not require cleaning. It is then disposed with the individual use container. There is an overflow lip 55 that collects and liquid that may be forced or spilled from the single use container. The driven pulley 54 turns in the frame of the dispensing apparatus 10 on the inner ring 53. While the grater/grinder 60 turns, product within the single use container is pushed through the single use container. As seen in FIG. 4, a rain 72 is used to push the product to/through the grater/grinder 60. The rain 72 is connected to a screw 71 that passes through the press motor 70. The motor 70 is secured to a frame 35 that prevents rotation of the single use product. The press motor 70 operates as a linear actuator where the screw 71 turns 99 or is driven 98 to move the rain 72 up or down, as shows with the lowered rain 72L in broken lines. While the rain 72 moves the drive pulley turns 95 to move 94 the belt 52 to remove product from the single use cup where the product will fall through the grater/grinder 60 and into a cup, bowl or glass below.

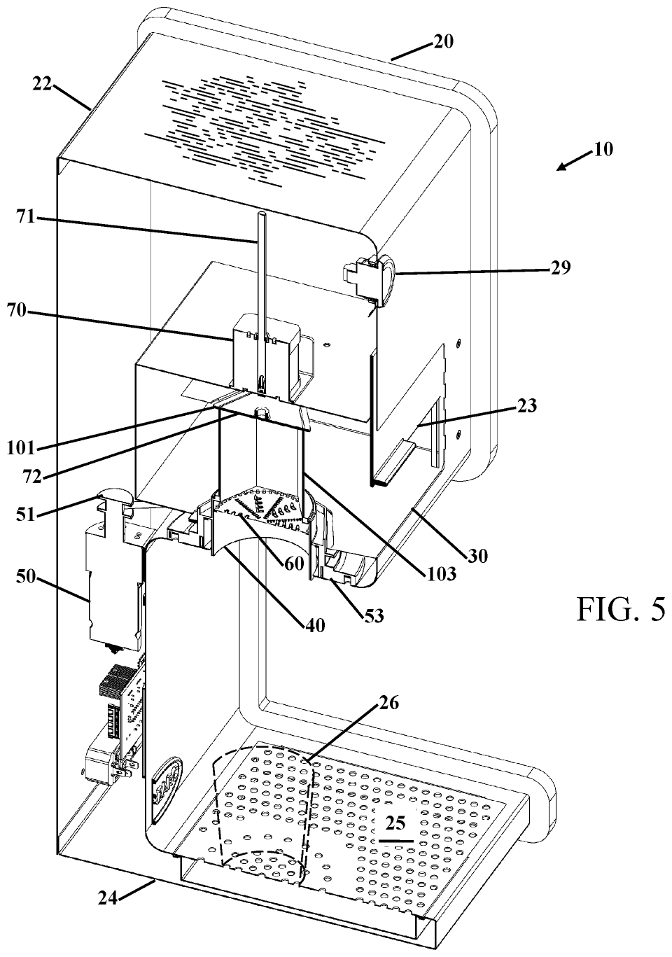

FIG. 5 shows a cross-section of the dispensing apparatus 10 with a parfait being dispensed. Because most of these components have been previously described they will be briefly identified in this view. The housing is shown with the base 24, cover 22 and the right-side housing 20. The front of the housing shows the opening 30 and a door 23 where the single use container is placed therethrough for transfer dispensing. There is a single start button 29 to begin the dispensing operation.

The motor 70 drives the screw 71 to push the rain 72 downward from the upper lip 101 down into the grinder/grater plate 60 blades or scoops that shave product from within the sides 103 of the single use container. While the figure shows the container having sides 103, the container only needs to have a single feature or key that prevents rotation of the container as the grinder/grater plate 60 is rotated in the inner ring 53 from the rotation motor 50 turning a belt connected between the drive pulley 51 and the inner ring 53. Product shaved from within the individual use container falls through the side wall 40 and land in a similar layered pattern in the cup, glass or bowl 26 on the collection tray top 25.

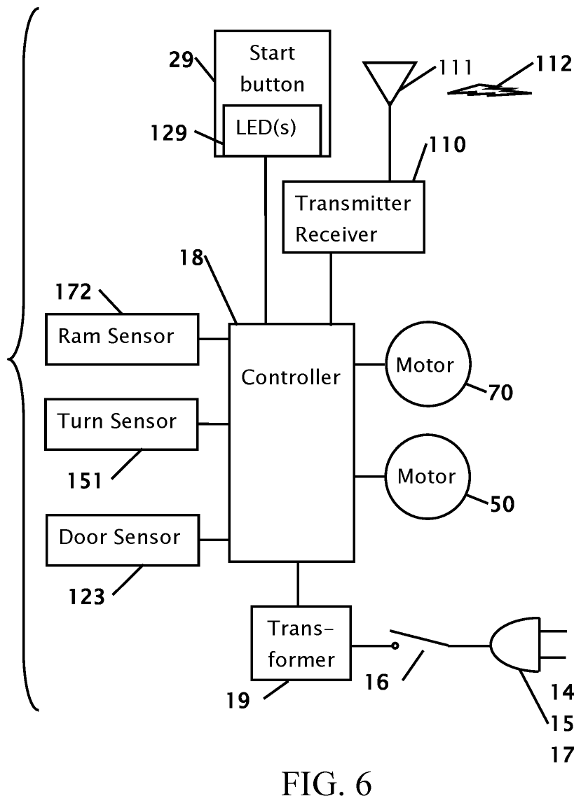

FIG. 6 shows a block diagram of the dispensing apparatus that is controlled by a controller 18. Power from one or more of the power connections 14, 15, 17 passes through a switch 16 where the incoming voltage is converted by a transformer 19 or other power conversion apparatus to operate the dispensing apparatus. The start button 29 notifies the controller that the user wants the dispensing apparatus to begin operation. A display or an LED 129 can provide some notification to the user that the dispensing is taking place or if there is an error, like the door is opened and detected by the door sensor 123. The controller is connected to one or more sensor, like a turn sensor 151 that monitors the rotation motor 50 and a rain sensor 172 that determines the position or end of stroke of the rain from the rain motor 70. While not required, the dispensing apparatus may have a wired or wireless transmitter/receiver 110, antenna 111 that can send and/or receive a signal 112 for use or maintenance.

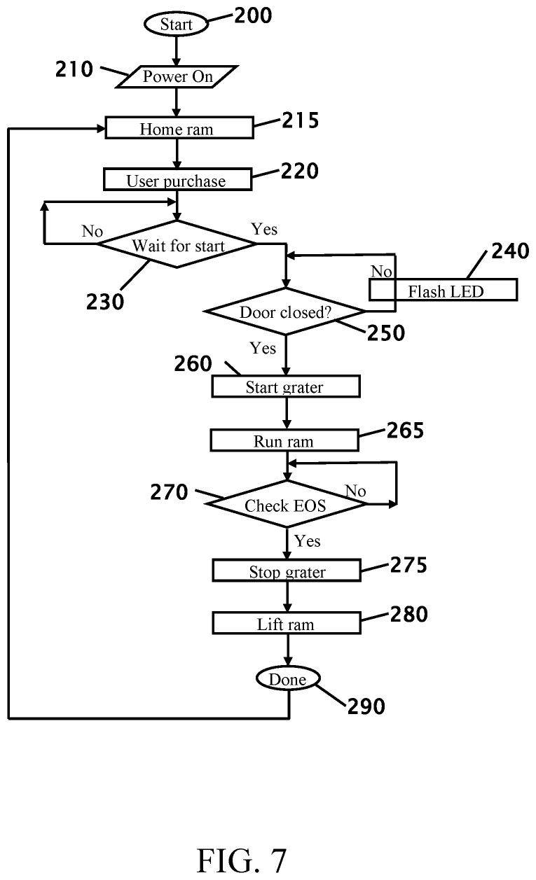

FIG. 7 shows a flow chart for using the dispensing apparatus. From the start 200 when a user powers on 210 the dispensing apparatus. The dispensing apparatus will perform a power-on check, return the rain to a home position 215 and make sure the dispensing apparatus is ready to accept a product. The product is usually stored in a refrigerator or freezer in a home or store. Seals or covers on one or both sides of the product are removed. After the product is selected, purchased 220 (or before purchasing) the product is placed in the dispensing apparatus where the dispensing apparatus waits 230 for the start button (29 not shown in this figure) to be pressed. Some safety checks are performed, like ensuring the door is closed 250 and if not, the start button or other indicator could flash and LED 240 until the dispensing apparatus is ready to start.

The grater starts 260 and a sensor(s) ensure rotation is taking place before the rain pushes 265 the product through the individual use container and through the grater. The process continues until the rain completes the stroke and is at the end of stroke (EOS) 270. The grater is stopped 275 and the rain is lifted 280 to return to a home position 215 where the dispensing process is done 290 and the user can remove the layered product.

Thus, specific embodiments of a layered drink or dessert dispensing apparatus have been disclosed. It should be apparent, however, to those skilled in the art that many more modifications besides those described are possible without departing from the inventive concepts herein. The inventive subject matter, therefore, is not to be restricted except in the spirit of the appended claims.

1. A layered drink or dessert dispensing apparatus comprising:
a rain that is configured to push a layered drink or dessert through a container into a rotating plate;
said rotating plate having at least one blade, and
said rotating plate turns as said rain is pushed to remove product from within said container to maintain said layered drink or dessert from said container into a glass, cup, dish, or bowl.

2. The layered drink or dessert dispensing apparatus according to claim 1, further includes a motor that is configured to turn said rotating plate.

3. The layered drink or dessert dispensing apparatus according to claim 1, wherein said rain is moved with a linear actuator.

4. The layered drink or dessert dispensing apparatus according to claim 1, wherein said layered drink or dessert is chilled.

5. The layered drink or dessert dispensing apparatus according to claim 1, wherein said container includes a single serving of said layered drink or dessert.

6. The layered drink or dessert dispensing apparatus according to claim 1, wherein said at least one blade is configured to scoop or shave said layered drink or dessert in helical layers.

7. The layered drink or dessert dispensing apparatus according to claim 1, wherein said at least one blade is a grater or grinder having a plurality of blades or scoops.

8. The layered drink or dessert dispensing apparatus according to claim 1, further includes a housing with an opening having a door.

9. The layered drink or dessert dispensing apparatus according to claim 8, further includes a sensor that determines if said container is properly installed in said opening.

10. The layered drink or dessert dispensing apparatus according to claim 8, further includes a sensor that determines if said door is closed.

11. The layered drink or dessert dispensing apparatus according to claim 8, further includes a collection tray located below said at least one blade.

12. The layered drink or dessert dispensing apparatus according to claim 8, further includes a user interface.

13. The layered drink or dessert dispensing apparatus according to claim 12, wherein said user interface includes at least one of a display, a scanner and a button.

14. The layered drink or dessert dispensing apparatus according to claim 11 further includes a bowl or glass whereby said layered drink or dessert is collected in a layered configuration.

15. The layered drink or dessert dispensing apparatus according to claim 1, wherein container has at least one keyed side that is configured to prevent rotation of said container as said at least one blade is turning.

16. The layered drink or dessert dispensing apparatus according to claim 15, wherein said container is a multi-sided container.

17. The layered drink or dessert dispensing apparatus according to claim 15, further includes a housing having an anti-rotation frame that is configured to prevent rotation of said container.

18. The layered drink or dessert dispensing apparatus according to claim 1, further includes at least one rain location sensor.

19. The layered drink or dessert dispensing apparatus according to claim 1, wherein said layered drink or dessert includes at least two different layers.

20. The layered drink or dessert dispensing apparatus according to claim 1, wherein said layered drink or dessert is a thick liquid or a semi-solid frozen product.
